(19) United States
(12) Patent Application Publication
(10) Pub. No.: US 2026/0141552 A1
(43) Pub. Date: May 21, 2026

(54) Systems, Methods, and Devices for Robust Visual Localization in Compute-Constrained Environments

(71) Applicant: California Institute of Technology, Pasadena, CA (US)

(72) Inventors: Tu-Hoa Pham, Pasadena, CA (US); Philip Bailey, Pasadena, CA (US)

(73) Assignee: California Institute of Technology, Pasadena, CA (US)

(21) Appl. No.: 19/393,259

(22) Filed: Nov. 18, 2025

Related U.S. Application Data
(60) Provisional application No. 63/721,682, filed on Nov. 18, 2024.

(51) Int. Cl. G06T 7/70; G06T 7/13; G06T 7/50; G06T 17/20; G06V 10/46; G06V 10/74; G06V 10/75; G06V 10/764

(52) U.S. Cl. CPC G06T 7/70; G06T 7/13; G06T 7/50; G06T 17/20; G06V 10/462; G06V 10/751; G06V 10/761; G06V 10/764; G06T 2207/30244

(57) ABSTRACT

Systems and methods in accordance with several embodiments of the invention may enable robust visual localization. One embodiment includes a method that derives test images from a camera depicting a scene with a target area. A three-dimensional mesh model is generated for the target area, comprising object polygons. The method iterates over polygons to build a depth map, then identifies salient edges using a pre-determined discontinuity threshold for depth estimates. An ideal edge map is derived from the salient edges. Baseline images of a virtual scene representation are synthesized from an initial camera pose perspective, incorporating the ideal edge map. Template matching between test and baseline images derives a mapping for estimating the specific camera pose.

### CROSS-REFERENCE TO RELATED APPLICATIONS

This application claims priority to U.S. Provisional Patent Application No. 63/721,682, titled “A novel FFT-accelerated template matching metric for robust localization in noisy environments,” filed Nov. 18, 2024, which is hereby incorporated by reference in its entirety.

### STATEMENT REGARDING FEDERALLY SPONSORED RESEARCH

This invention was made with government support under Grant No. 80NM0018D0004 awarded by NASA (JPL). The government has certain rights in the invention.

### FIELD OF INVENTION

The present disclosure relates to computer vision and robotic localization systems, and more particularly to visual pose estimation methods for objects in resource-constrained computing environments.

### BACKGROUND

NASA's Perseverance rover successfully landed on Mars in 2021 with the primary mission of collecting rock and atmosphere sample tubes for comprehensive study. The rover has been systematically gathering samples from the Martian surface, storing them in sealed containers that preserve the integrity of the collected materials for future analysis. To facilitate the return of these valuable samples to Earth, scientists have conceived of a potential approach involving a dedicated return lander that would rendezvous with Perseverance on the Martian surface.

This return lander would be equipped with a sophisticated robotic arm capable of retrieving the collected sample tubes from the rover's bit carousel (BC), which is a rotating mechanical system designed to store and provide multiple tool bits that facilitate sample acquisition and surface analysis operations. The bit carousel serves as both a storage mechanism and an interface point where sample tubes can be accessed and transferred between systems. Following the successful retrieval of samples, the return lander's robotic arm would then carefully load these sample tubes into an orbiting sample (OS) canister, which would subsequently be launched into Mars orbit and eventually returned to Earth for detailed scientific analysis.

The operational environment for such missions presents numerous challenges, including extreme temperature variations, dust accumulation, limited communication windows with Earth, and the need for autonomous operation over extended periods. Additionally, the precision required for robotic manipulation tasks in space applications demands highly accurate positioning and control systems that can function reliably under these harsh conditions. The computational resources available for such missions are typically constrained due to the need for radiation-hardened components and power limitations inherent in space-based systems.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Systems and techniques performing robust visual localization in compute-constrained environments are illustrated. One embodiment includes a method for robust visual localization in compute-constrained environments. The method derives, from a camera with a specific pose, at least one test image depicting a scene including a target area. The method generates a three-dimensional (3D) mesh model corresponding to the target area depicted in the scene, wherein the 3D mesh model comprises a plurality of object polygons. The method iterates over each of the plurality of object polygons to build a depth map of the target area. The method identifies a set of salient edges corresponding to the depth map, wherein the set of salient edges is identified according to a pre-determined discontinuity threshold for depth estimates on the depth map. The method derives an ideal edge map for the target area from the set of salient edges. The method synthesizes at least one baseline image of a virtual representation of the scene from the perspective of an initial camera pose, wherein the at least one baseline image comprises the ideal edge map. The method performs template matching between the at least one test image and the at least one baseline image to derive a mapping for estimating the specific pose.

In a further embodiment, the method iteratively updates the initial camera pose based on the mapping to estimate the specific pose until convergence criteria are met.

In another embodiment, the convergence criteria comprise pose changes of less than 0.5 mm for translation and less than 0.5 degrees for rotation between consecutive iterations.

In another embodiment, performing template matching includes: generating a binary edge map corresponding to each of the at least one test image and a template image extracted from the at least one baseline image; determining a similarity mask for the template image based on whether each individual pixel corresponds to rendered object material or should be ignored; quantifying pixels that are simultaneously edges or simultaneously non-edges on both the test image and template image; and deriving a weighted hamming similarity score from the similarity mask, test image, template image, and quantified pixels as a weighted sum to evaluate similarity between the test image and template image.

In a further embodiment, generating the binary edge map corresponding to the at least one test image comprises applying Canny edge detection to an intensity image captured by the camera.

In another embodiment, the method establishes 2D-3D correspondences between pixels in the at least one test image and 3D points on the target area using the mapping; and calculates a best-fitting camera pose from the 2D-3D correspondences using a Perspective-n-Point Random Sample Consensus algorithm.

In still another embodiment, the Perspective-n-Point Random Sample Consensus algorithm classifies the 2D-3D correspondences as inliers or outliers based on reprojection error thresholds that are progressively tightened during iterative pose refinement.

One embodiment includes a localization system for robust visual localization in compute-constrained environments. The system includes a camera; a memory storing instructions; and a processor configured to execute the instructions to perform various actions. The processor is configured to derive, from the camera, when the camera has a specific pose, at least one test image depicting a scene including a target area. The processor is configured to generate a three-dimensional (3D) mesh model corresponding to the target area depicted in the scene, wherein the 3D mesh model comprises a plurality of object polygons. The processor is configured to iterate over each of the plurality of object polygons to build a depth map of the target area. The processor is configured to identify a set of salient edges corresponding to the depth map, wherein the set of salient edges is identified according to a pre-determined discontinuity threshold for depth estimates on the depth map. The processor is configured to derive an ideal edge map for the target area from the set of salient edges. The processor is configured to synthesize at least one baseline image of a virtual representation of the scene from the perspective of an initial camera pose, wherein the at least one baseline image comprises the ideal edge map. The processor is configured to perform template matching between the at least one test image and the at least one baseline image to derive a mapping for estimating the specific pose.

In a further embodiment, the memory further stores instructions that, when executed by the processor, cause the system to iteratively update the initial camera pose based on the mapping to estimate the specific pose until convergence criteria are met.

In another embodiment, the convergence criteria comprise pose changes of less than 0.5 mm for translation and less than 0.5 degrees for rotation between consecutive iterations.

In another embodiment, performing template matching includes: generating a binary edge map corresponding to each of the at least one test image and a template image extracted from the at least one baseline image; determining a similarity mask for the template image based on whether each individual pixel corresponds to rendered object material or should be ignored; quantifying pixels that are simultaneously edges or simultaneously non-edges on both the test image and template image; and deriving a weighted hamming similarity score from the similarity mask, test image, template image, and quantified pixels as a weighted sum to evaluate similarity between the test image and template image.

In a further embodiment, generating the binary edge map corresponding to the at least one test image comprises applying Canny edge detection to an intensity image captured by the camera.

In another embodiment, the memory further stores instructions that, when executed by the processor, cause the system to: establish 2D-3D correspondences between pixels in the at least one test image and 3D points on the target area using the mapping; and calculate a best-fitting camera pose from the 2D-3D correspondences using a Perspective-n-Point Random Sample Consensus algorithm.

In still another embodiment, the Perspective-n-Point Random Sample Consensus algorithm classifies the 2D-3D correspondences as inliers or outliers based on reprojection error thresholds that are progressively tightened during iterative pose refinement.

One embodiment includes a non-transitory computer-readable medium comprising instructions that, when executed, are configured to cause a processor to perform a method for robust visual localization in compute-constrained environments. The method derives, from a camera with a specific pose, at least one test image depicting a scene including a target area. The method generates a three-dimensional (3D) mesh model corresponding to the target area depicted in the scene, wherein the 3D mesh model comprises a plurality of object polygons. The method iterates over each of the plurality of object polygons to build a depth map of the target area. The method identifies a set of salient edges corresponding to the depth map, wherein the set of salient edges is identified according to a pre-determined discontinuity threshold for depth estimates on the depth map. The method derives an ideal edge map for the target area from the set of salient edges. The method synthesizes at least one baseline image of a virtual representation of the scene from the perspective of an initial camera pose, wherein the at least one baseline image comprises the ideal edge map. The method performs template matching between the at least one test image and the at least one baseline image to derive a mapping for estimating the specific pose.

In a further embodiment, the method iteratively updates the initial camera pose based on the mapping to estimate the specific pose until convergence criteria are met.

In another embodiment, the convergence criteria comprise pose changes of less than 0.5 mm for translation and less than 0.5 degrees for rotation between consecutive iterations.

In another embodiment, performing template matching includes: generating a binary edge map corresponding to each of the at least one test image and a template image extracted from the at least one baseline image; determining a similarity mask for the template image based on whether each individual pixel corresponds to rendered object material or should be ignored; quantifying pixels that are simultaneously edges or simultaneously non-edges on both the test image and template image; and deriving a weighted hamming similarity score from the similarity mask, test image, template image, and quantified pixels as a weighted sum to evaluate similarity between the test image and template image.

In a further embodiment, generating the binary edge map corresponding to the at least one test image comprises applying Canny edge detection to an intensity image captured by the camera.

In another embodiment, the method establishes 2D-3D correspondences between pixels in the at least one test image and 3D points on the target area using the mapping; and calculates a best-fitting camera pose from the 2D-3D correspondences using a Perspective-n-Point Random Sample Consensus algorithm.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure. The foregoing general description of the illustrative embodiments and the following detailed description thereof are merely exemplary aspects of the teachings of this disclosure and are not restrictive.

### BRIEF DESCRIPTION OF FIGURES

The description and claims will be more fully understood with reference to the following figures and data graphs, which are presented as exemplary embodiments of the invention and should not be construed as a complete recitation of the scope of the invention.

FIG. 1 illustrates examples of general, synthetic, and testbed visualizations of a bit carousel (BC) and an orbiting sample (OS) canister.

FIGS. 2A-2B illustrates examples of test image visualizations and low-fidelity renderings that may be used to derive low-accuracy salient edge visualizations.

FIG. 3 illustrates a process used to produce high-precision pose estimates in accordance with several embodiments of the invention.

FIG. 4 illustrates a virtual scene generated using processes implemented in accordance with multiple embodiments of the invention.

FIG. 5 illustrates a process used to derive edge maps in accordance with miscellaneous embodiments of the invention.

FIG. 6A-6B illustrates baseline images generated through edge evaluation processes operating in accordance with many embodiments of the invention.

FIG. 7A-7C illustrates test images generated in accordance with certain embodiments of the invention.

FIG. 8 illustrates a process used to assess weighted hamming similarity in accordance with numerous embodiments of the invention.

FIG. 9 illustrates a visual representation of weighted hamming similarity in accordance with a number of embodiments of the invention.

FIG. 10 illustrates template matching using weighted Hamming similarity against edges produced in accordance with various embodiments of the invention.

FIG. 11 illustrates template matching output generated using processes produced in accordance with many embodiments of the invention.

FIGS. 12-13 conceptually illustrate systems implemented for pose estimation performed in accordance with some embodiments of the invention.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

A detailed description of systems, devices, and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

### I. Localization Methods

Localization systems configured to perform robust monocular pose estimation in compute and memory-constrained environments in accordance with various embodiments of the invention are described herein. The localization systems may utilize various processes including but not limited to a render-and-compare algorithm for iterative pose refinement, salient edge rendering processes for generating synthetic baseline images, weighted hamming similarity processes for template matching in edge domains, and pose estimation and validation processes that combine the aforementioned processes for accurate localization. The render-and-compare algorithm may generate virtual scene representations and iteratively refine camera pose estimates through template matching between test images and synthesized baseline images. Salient edge rendering processes may create ideal edge maps from low-fidelity 3D models by identifying discontinuities in depth buffers and surface normals, thereby avoiding computational overhead associated with realistic rendering while maintaining geometric accuracy. Weighted hamming similarity processes may provide robust template matching metrics that account for both edge and non-edge pixels through normalized scoring functions, enabling effective matching despite sim-to-real discrepancies. Pose estimation and validation processes may integrate the render-and-compare algorithm, salient edge rendering, and weighted hamming similarity to achieve localization within tight accuracy margins while operating under severe computational constraints.

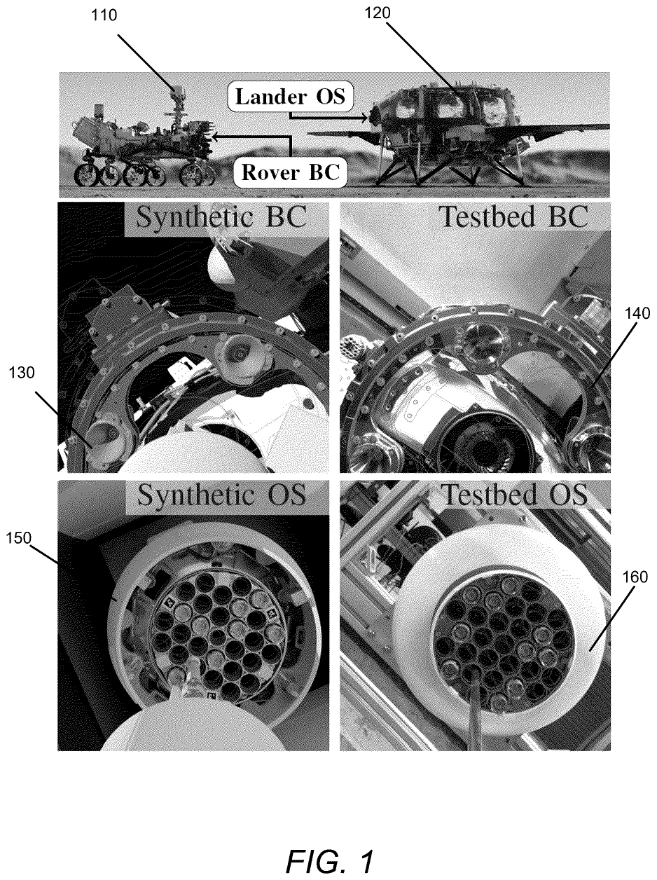

FIG. 1 illustrates examples of general, synthetic, and testbed visualizations of a bit carousel (BC) and an orbiting sample (OS) canister that might be aligned using processes in accordance with some embodiments of the invention. Specifically, Mars Sample Return operations may represent (non-exclusive) scenarios where precise localization becomes necessary for automated systems (e.g., rovers, landers) operating under constrained conditions. A rover bit carousel (BC) 110 serves as a sample storage mechanism on a planetary rover, containing multiple sample tubes collected during exploration missions. A lander orbiting sample (OS) 120 functions as a receiving canister on a sample return lander, configured to accept sample tubes transferred from the rover bit carousel (BC) 110. Sample tube transfer operations between these components may require localization accuracy of 0.4 mm and 0.25° from initial uncertainties of 75 mm and 5°, operating under severely constrained hardware conditions (e.g., a single-core 200 MHz processor with only 10 MB of RAM available for localization tasks). The localization systems may complete processing within a 30-minute time budget for complete localization of both the rover bit carousel (BC) 110 and the lander orbiting sample (OS) 120 stations.

Localization systems in accordance with numerous embodiments of the invention may utilize low-fidelity 3D models for monocular pose estimation, in as many as six degrees-of-freedom (6-DoF), enabling robust operation in resource-constrained environments. As shown in FIG. 1, synthetic representations including but not limited to a synthetic BC 130 and a synthetic OS 150 may provide computer-generated models that capture geometric features without requiring high-fidelity textures or complex lighting calculations. Testbed implementations including but not limited to a testbed BC 140 and a testbed OS 160 may serve as physical validation platforms that bridge the gap between synthetic models and real-world operational conditions. The localization systems may leverage these synthetic representations 130, 150 and testbed implementations 140, 160 to develop and validate pose estimation algorithms that can operate effectively despite discrepancies between low-fidelity models and actual hardware configurations encountered during mission operations, as disclosed below. In many embodiments of the invention, these algorithms may be based on, but are not limited to synthetic representations (e.g., low-fidelity renderings) and sensor data.

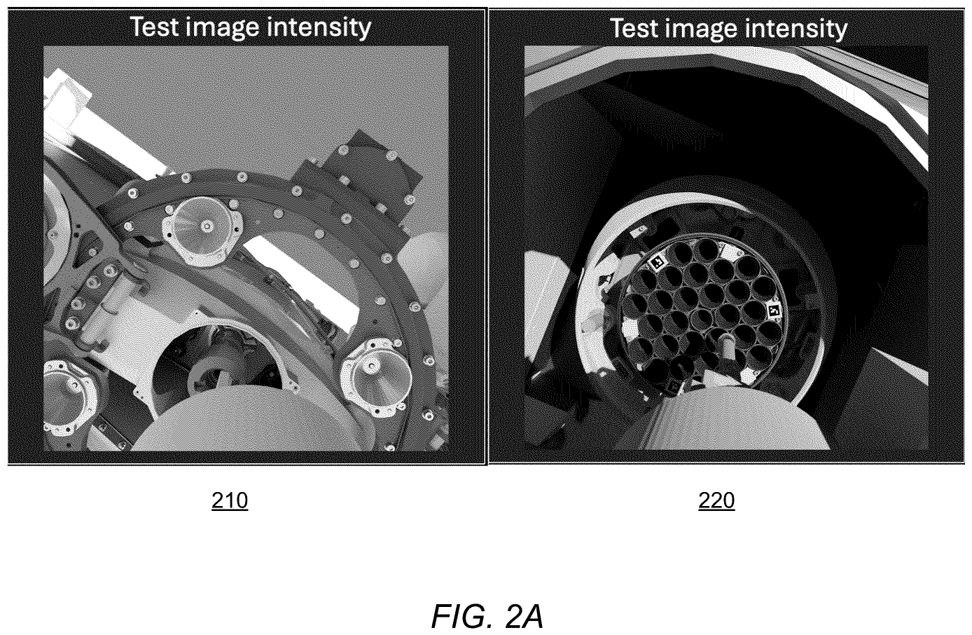

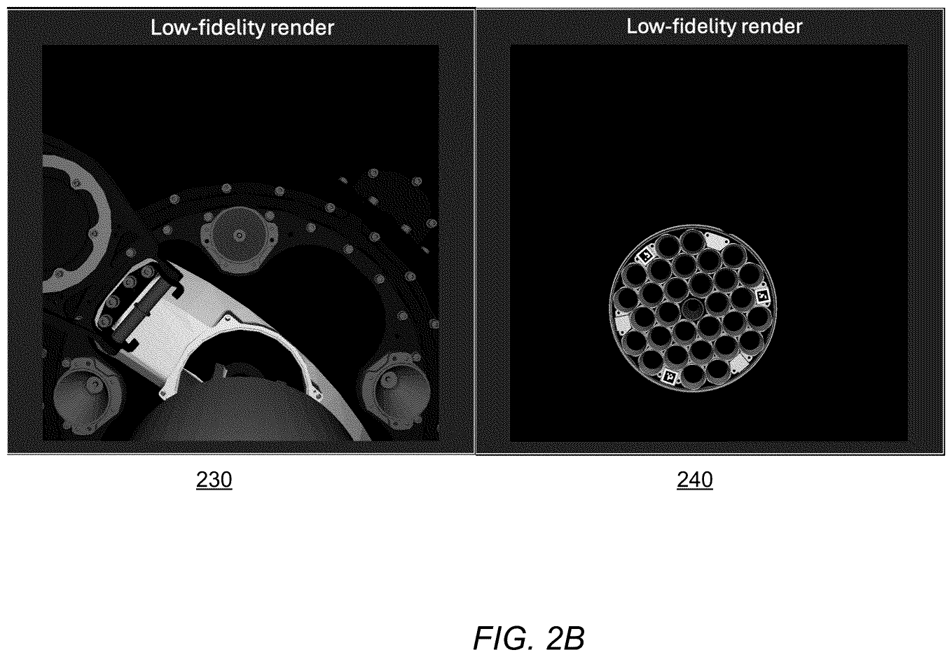

FIGS. 2A-2B illustrates examples of test image visualizations and low-fidelity renderings that may be used to derive low-accuracy salient edge visualizations. Localization systems in accordance with various embodiments of the invention may process test images captured from cameras with specific poses to enable pose estimation operations. The BC intensity image 210 of FIG. 2A corresponds to a test image that depicts a scene including a target station corresponding to a rover bit carousel. The use of intensity images (compared to test images) emphasizes edges for subsequent processing operations; however unmodified test images may be used in accordance with many embodiments of the invention. The OS intensity image 220 similarly corresponds to a test image that depicts a scene including a target station corresponding to a lander orbiting sample canister, providing intensity information that facilitates edge detection and template matching processes. The test images may undergo additional/alternative processing methods including but not limited to histogram equalization preprocessing to further increase global contrast before edge detection operations, thereby enhancing the visibility of structural features and geometric boundaries within the captured scenes.

With reference to FIG. 2B, localization systems may generate synthesized baseline images rendered from virtual camera pose hypotheses to enable comparison operations with test images. The BC low-fidelity render 230 provides a synthesized baseline image of the rover bit carousel target station, generated from a virtual camera pose estimate without requiring compute-intensive characteristics (e.g., high-fidelity textures, complex lighting calculations). The OS low-fidelity render 240 similarly provides a synthesized baseline image of the lander orbiting sample canister, rendered using geometric models that capture structural features while maintaining computational efficiency. The synthesized baseline images 230, 240 may serve as reference representations for template matching operations against corresponding test images 210, 220, enabling iterative refinement of camera pose estimates through comparison processes.

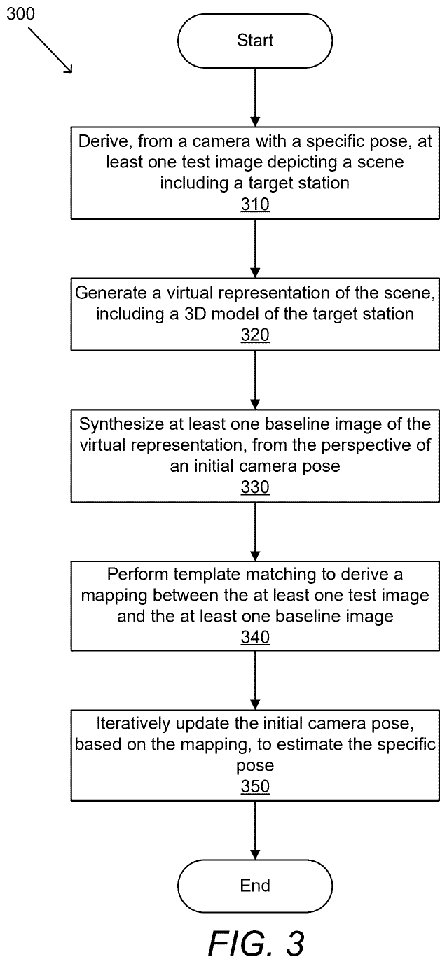

An example of a process for performing render-and-compare localization in accordance with some embodiments of the invention is illustrated in FIG. 3. Process 300 derives (310), from a camera with a specific pose, at least one test image depicting a scene including a target station. The camera may operate using undistorted images processed through pressure and temperature-sensitive camera models with pinhole camera parameters including but not limited to focal lengths and image center coordinates. Process 300 generates (320) a virtual representation of the scene, including a 3D model of the target station. The virtual representations may populate a virtual scene with current estimates of world state, including 3D models of target stations and current pose estimates relative to camera positions.

Process 300 synthesizes (330) at least one baseline image of the virtual representation, from the perspective of an initial camera pose. The baseline image synthesis may utilize virtual camera frames positioned relative to landmark (e.g., target station) frames, where initial camera pose estimates may be derived from predefined ready poses (e.g., provided to robotic arm controllers). Process 300 performs (340) template matching to derive a mapping between the at least one test image and the at least one baseline image. The template matching operations may establish correspondences between baseline pixels and test pixels, enabling derivation of 2D-3D mappings/correspondences through controlled rendering processes that provide access to 3D points associated with baseline pixels.

Process 300 iteratively updates (350) the initial camera pose, based on the mapping, to estimate the specific pose. The iterative refinement process may continue updating camera pose estimates until convergence criteria are met (e.g., convergence within 0.5 mm and) 0.5° over consecutive iterations. The iterative pose estimation process may include early exit conditions when pose estimates exceed plausible ranges, typically defined as double the input uncertainties, thereby preventing convergence to implausible pose solutions.

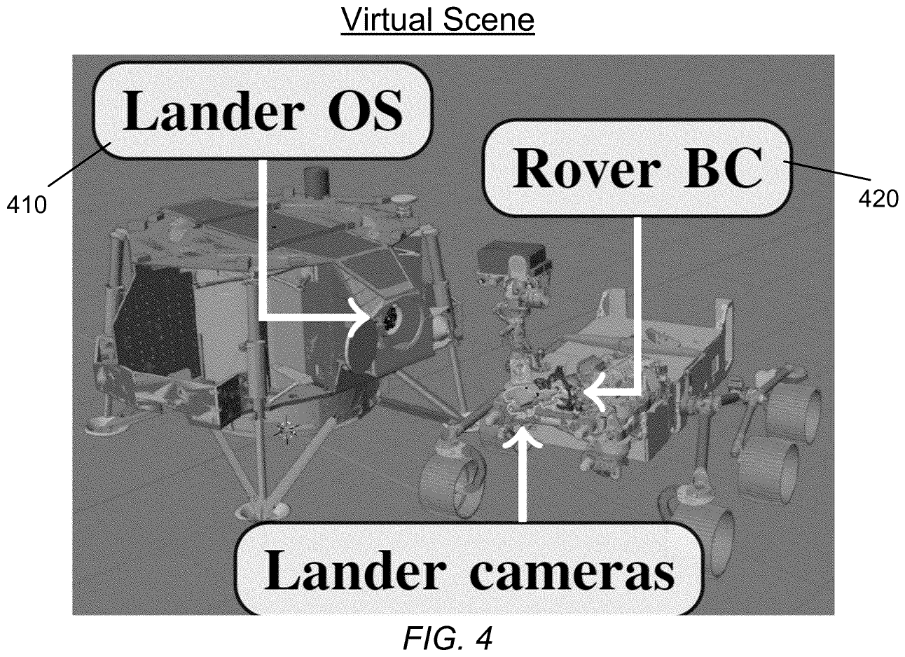

As shown in FIG. 4, localization systems may generate virtual scenes including but not limited to 3D models of targets (e.g., target stations) to support render-and-compare operations. The BC virtual scene 410 represents a virtual environment containing a 3D model of a rover bit carousel target station, positioned within a simulated operational context that includes surrounding environmental elements. The OS virtual scene 420 similarly represents a virtual environment containing a 3D model of a lander orbiting sample canister, configured to support baseline image synthesis from various virtual camera pose hypotheses. The virtual scenes 410, 420 may enable generation of synthesized baseline images that can be compared against test images captured from actual camera positions, facilitating iterative pose refinement through template matching operations.

Localization systems in accordance with numerous embodiments of the invention may implement adaptive optimization schedules that control various parameters throughout iterative pose estimation processes. The optimization schedules may control template sizes, starting with larger templates for increased saliency then decaying template dimensions for finer pose estimation as iterations progress. Search area sizes within test images may be initially derived from input uncertainties and subsequently tightened over time as pose estimates converge toward accurate solutions. Reprojection error thresholds for inlier classification may be progressively reduced, such as halving thresholds every iteration down to predetermined minimum values, thereby improving pose estimation accuracy as the iterative process advances toward convergence.

While specific processes are described above with reference to FIGS. 2A-4, render-and-compare localization algorithms can be implemented in any of a number of different ways as appropriate to the requirements of specific applications in accordance with some embodiments of the invention. In multiple embodiments, steps may be executed or performed in any order or sequence not limited to the order and sequence shown and described. In numerous embodiments, some of the above steps may be executed or performed substantially simultaneously where appropriate or in parallel to reduce latency and processing times. In several embodiments, one or more of the above steps may be omitted. Additionally, the specific manner in which render-and-compare algorithms can be utilized within localization systems in accordance with various embodiments of the invention is largely dependent upon the requirements of a given application.

Salient edge rendering processes in accordance with various embodiments of the invention may generate ideal edge maps from 3D mesh models. These edge maps may be applied to enable template matching operations without requiring high-fidelity intensity image rendering. Specifically, the salient edge rendering processes may produce edge maps that serve as baseline images for template matching against test images processed through edge detection algorithms, thereby avoiding computational overhead associated with realistic rendering while maintaining geometric accuracy for pose estimation operations. Localization systems may utilize salient edge rendering to circumvent challenges associated with balancing rendering realism versus computation time, enabling effective operation under severe hardware constraints while providing robust correspondence matching capabilities.

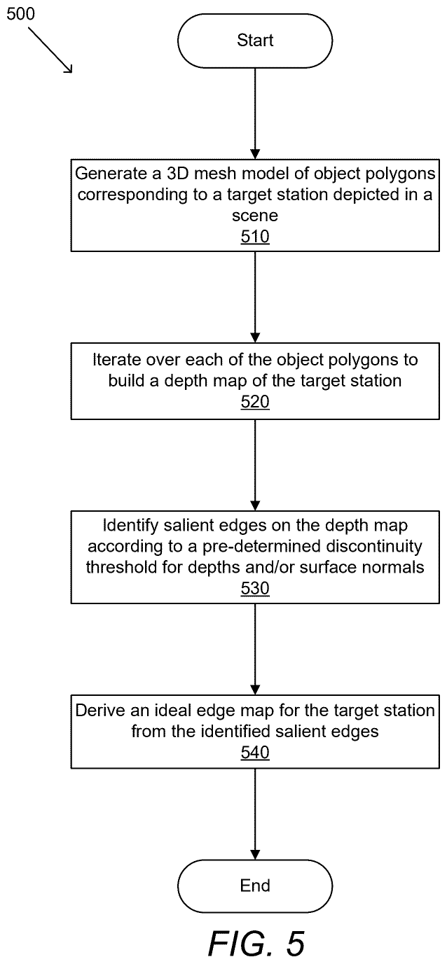

An example of a process for generating ideal edge maps from target stations in accordance with some embodiments of the invention is illustrated in FIG. 5. Process 500 generates (510) a 3D mesh model of object polygons corresponding to a target station depicted in a scene. The 3D mesh models may comprise triangular polygons that define geometric surfaces of target stations including but not limited to rover bit carousels and lander orbiting sample canisters.

Process 500 iterates (520) over each of the object polygons to build a depth map of the target station. Localization systems in accordance with numerous embodiments of the invention may build depth maps through iterative processing of the object polygons that make up the 3D mesh models of target stations. The depth map construction process may project each triangular polygon onto image planes using current camera pose estimates and intrinsic camera parameters including but not limited to focal lengths and image center coordinates. The systems may maintain depth buffer representations by tracking minimum distances at each pixel location, thereby establishing 2D matrices where pixel values correspond to depths of nearest objects intersecting corresponding camera rays or predetermined maximum values for pixels without object intersections. The depth map construction may involve projecting 3D triangles onto image planes using current relative camera poses and camera parameters, maintaining tracking of lowest distances at each pixel to establish depth buffer representations.

Process 500 identifies (530) salient edges on the depth map according to a pre-determined discontinuity threshold for depths and/or surface normals. The salient edge identification may utilize specific discontinuity thresholds including but not limited to surface normal thresholds that may be determined based on object geometry characteristics and depth thresholds that may be established based on mesh discretization parameters. The depth discontinuity approach may identify silhouette edges by detecting pixels bordering discontinuities in depth buffers, where discontinuity thresholds may range from 1 mm to 10 mm based on mesh discretization parameters and target station dimensions. The surface normal threshold approach may identify salient edges between faces forming angles beyond a certain threshold (e.g., 30° or greater), providing automatic edge marking for texture-less objects based on geometric discontinuities. That said, alternative threshold values may be utilized depending on object geometry characteristics and mesh resolution requirements, with threshold ranges spanning 15° to 45° for different application scenarios. Process 500 derives (540) an ideal edge map for the target station from the identified salient edges. The ideal edge map derivation may generate binary representations where edge pixels correspond to identified salient features and non-edge pixels correspond to smooth surface regions or background areas.

While specific processes are described above with reference to FIG. 5, salient edge rendering algorithms can be implemented in any of a number of different ways as appropriate to the requirements of specific applications in accordance with some embodiments of the invention. In numerous embodiments, steps may be executed or performed in any order or sequence not limited to the order and sequence shown and described. In a number of embodiments, some of the above steps may be executed or performed substantially simultaneously where appropriate or in parallel to reduce latency and processing times. In many embodiments, one or more of the above steps may be omitted. Additionally, the specific manner in which salient edge rendering algorithms can be utilized within localization systems in accordance with certain embodiments of the invention is largely dependent upon the requirements of a given application.

Further, in accordance with miscellaneous embodiments, rendering processes may extend depth buffer construction to provide depth maps and segmentation maps that associate each pixel to corresponding objects within scenes. The extended depth buffer construction may generate segmentation maps by tracking which objects are responsible for each depth buffer update during polygon iteration processes, enabling pixel-level association between image locations and specific scene objects including but not limited to orbiting sample canisters and sample tubes. The depth maps and segmentation maps may facilitate subsequent template matching operations by providing geometric context and object identification information for baseline image generation processes.

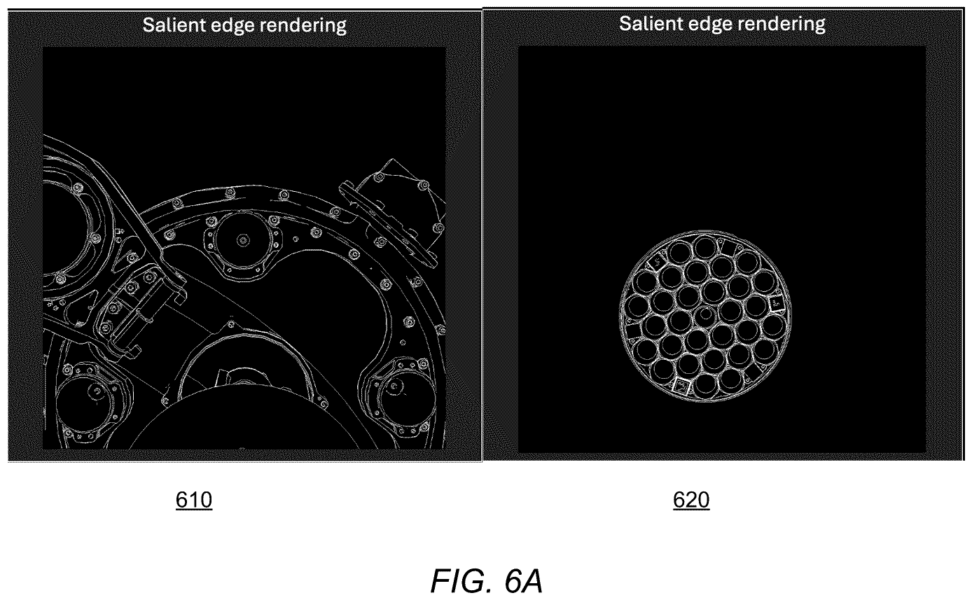

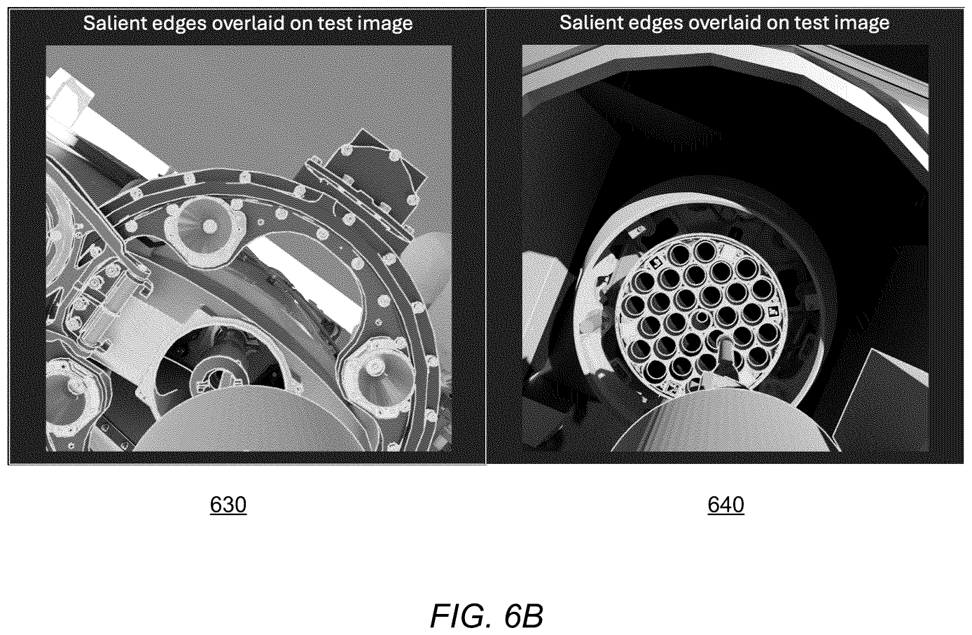

FIG. 6A-6B illustrates baseline images generated through edge evaluation processes operating in accordance with many embodiments of the invention. Referring to FIG. 6A, localization systems may generate salient edge renderings that serve as baseline images for template matching operations. A BC salient edge rendering 610 provides an ideal edge map derived from a 3D mesh model of a rover bit carousel target station, where salient edges correspond to geometric discontinuities identified through surface normal and depth threshold analysis. An OS salient edge rendering 620 similarly provides an ideal edge map derived from a 3D mesh model of a lander orbiting sample canister, capturing structural features and geometric boundaries without requiring complex lighting calculations or texture information. In FIG. 6B, salient edge renderings are overlaid on test images to visualize correspondence matching results and validate pose estimation accuracy. An OS salient edge rendering overlaid on test image 630 demonstrates alignment between ideal edge maps generated through salient edge rendering processes and actual geometric features captured in test images of lander orbiting sample canisters. A BC salient edge rendering overlaid on a test image 640 similarly shows correspondence between synthesized baseline edges and real structural features of rover bit carousel components. Both images reflect high accuracy of pose estimation quality through visual inspection of edge alignment accuracy.

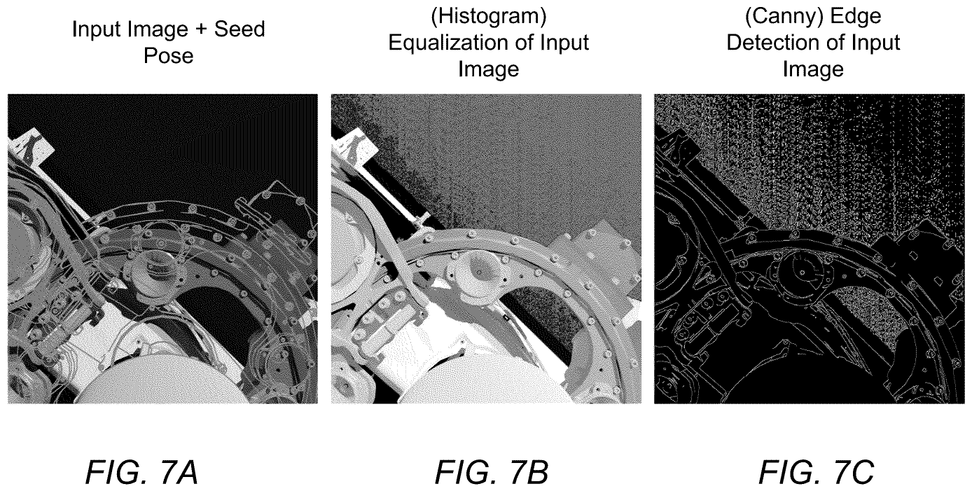

FIG. 7A-7C illustrates test images generated in accordance with certain embodiments of the invention. Localization systems may process test images through edge detection algorithms to generate binary edge maps suitable for template matching against salient edge renderings. The edge detection processes may include but are not limited to Canny edge detection methods and histogram equalization processing. FIG. 7A illustrates an input image combined with a seed pose, where initial pose estimates may be overlaid to provide reference positioning for subsequent processing operations. FIG. 7B depicts results after histogram equalization processing, which may enhance global contrast to improve visibility of structural features before edge detection operations. FIG. 7C shows an output after Canny edge detection processing, generating binary edge maps that highlight geometric boundaries and structural features suitable for comparison against salient edge renderings through template matching processes.

Localization systems configured in accordance with various embodiments of the invention may derive binary edge maps from salient edge rendering processes that can be overlaid on test images to facilitate template matching operations. The binary edge map derivation may generate representations where pixel values correspond to edge presence/absence, enabling direct comparison with binary edge maps derived from test images through edge detection algorithms. Binary edge maps may serve as baseline templates that capture geometric features of target stations without background elements or environmental factors that could introduce matching ambiguities during correspondence search operations.

Template matching processes performed in accordance with multiple embodiments may center templates on edge pixels from baseline images to improve robustness in correspondence finding operations. The template centering approach may select points of interest from salient edge renderings where edge pixels provide distinctive geometric features suitable for matching against corresponding locations in test images. Template extraction may generate sub-windows centered on selected edge pixels, creating baseline templates that capture local geometric patterns around salient features while excluding non-informative background regions that could degrade matching performance.

Weighted hamming similarity processes in accordance with various embodiments of the invention may provide robust template matching metrics for edge-based localization systems, and may enable effective correspondence matching between synthetic baseline images and real test images despite discrepancies arising from low-fidelity rendering approaches. Localization systems may utilize weighted hamming similarity to achieve accurate pose estimation while maintaining computational efficiency through normalized scoring functions that account for both edge and non-edge pixel distributions within template matching operations.

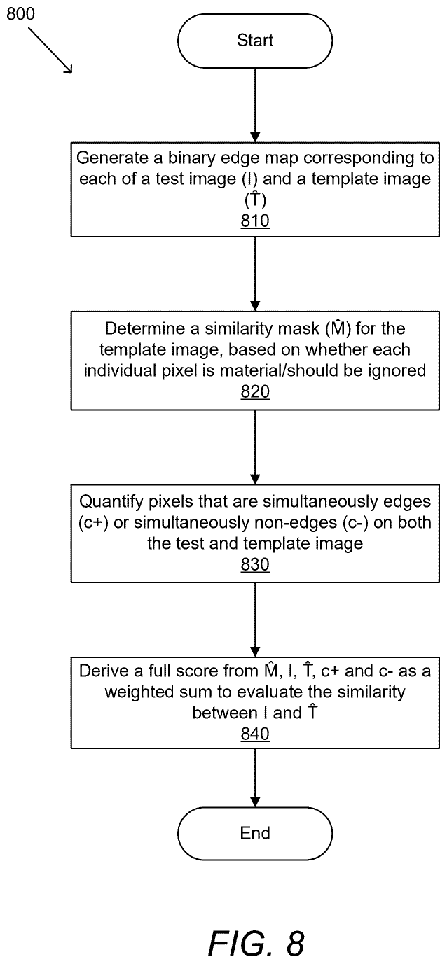

An example of a process for generating and evaluating weighted hamming similarity between images in accordance with some embodiments of the invention is illustrated in FIG. 8. Process 800 generates (810) a binary edge map corresponding to each of a test image (I) and a template image (T). The binary edge map generation may convert test images (and/or variations thereof, e.g., intensity images) into binary representations where pixel values correspond to edge presence (1) or absence (0), enabling direct comparison between synthetic baseline templates and real test images through edge-based matching operations. The binary edge map/may be derived from test images through edge detection algorithms including but not limited to Canny edge detection methods that identify structural boundaries and geometric features within captured intensity images. The binary edge map \hat{T} may be generated from template images extracted as subframes from baseline images produced through salient edge rendering processes, where template images capture local geometric patterns around selected points of interest within synthesized edge maps.

Process 800 determines (820) a similarity mask (\hat{M}) for the template image, based on whether each individual pixel corresponds to rendered object material or should be ignored. The similarity mask determination may distinguish between pixels that correspond to rendered object surfaces versus pixels that represent unrendered background regions or empty space within synthetic templates. The similarity mask determination may address challenges arising from synthetic template generation where zero-value pixels can represent either no-edge smooth surfaces of rendered objects or empty unrendered background space that should be excluded from matching operations. The similarity mask M may enable selective evaluation of template matching scores by identifying which pixels should contribute to similarity calculations versus which pixels should be ignored during correspondence search operations.

Process 800 quantifies (830) pixels that are simultaneously edges (c⁺) or simultaneously non-edges (c⁻) on both the test and template image. The pixel quantification operations may count correspondences where both template and test images contain edge pixels at corresponding locations, as well as correspondences where both images contain non-edge pixels at corresponding locations, thereby establishing measures of similarity across different pixel categories. Weighted hamming similarity processes may quantify at least two categories of pixel correspondences to establish comprehensive similarity measures between template and test images. The simultaneously edge pixels (c⁺) corresponding to locations where both template and test images contain edge pixels indicate alignment of geometric features and structural boundaries between synthetic and real representations. The simultaneously non-edge pixels (c⁻) corresponding to locations where both template and test images contain non-edge pixels, represent agreement in smooth surface regions or background areas between compared images. The quantification of these pixel correspondence categories may enable derivation of full similarity scores that account for both positive feature alignment and negative space agreement.

Process 800 derives (840) a full score from \hat{M}, I, Î, c⁺ and c⁻ as a weighted sum to evaluate the similarity between 1 and 1. The full score derivation may combine weighted contributions from edge and non-edge pixel correspondences to generate comprehensive similarity measures that account for geometric feature alignment while maintaining robustness to rendering discrepancies. The mathematical formulation of weighted hamming similarity may utilize normalized weighting factors to balance contributions from edge and non-edge pixel correspondences. The edge and non-edge pixel counts may be defined as c⁰ for masked-out pixels, c⁺ for edge pixels that should be masked in, and c⁻ for non-edge pixels that should be masked in, where c⁰+c⁺+c⁻=ŝ_{y}·ŝₓ, representing the total template image size. The score function may be expressed as

$${S}_{i , j} = {w}^{+} \cdot {S}_{i , j}^{+} + {w}^{-} \cdot {S}_{i , j}^{-} ,$$

where the weights are calculated as w⁺=1/c⁺ and w⁻=1/c⁻ when the respective pixel counts are greater than zero, and zero otherwise. The weighted hamming similarity score components

$$( {S}_{i , j}^{+} , {S}_{i , j}^{-} )$$

may be calculated across pixels using:

$${S}_{i , j}^{+} = {\sum }_{u = 0}^{{\hat{s}}_{y} - 1} {\sum }_{v = 0}^{{\hat{s}}_{x} - 1} {\hat{M}}_{u , v} \cdot ( {\hat{T}}_{u , v} == {I}_{i + u , j + v} == 1 )$$

$${S}_{i , j}^{-} = {\sum }_{u = 0}^{{\hat{s}}_{y} - 1} {\sum }_{v = 0}^{{\hat{s}}_{x} - 1} {\hat{M}}_{u , v} \cdot ( {\hat{T}}_{u , v} == {I}_{i + u , j + v} == 0 )$$

The weighted hamming similarity calculation can be reformulated using matrix operations for computational efficiency in various embodiments of the invention. Binary matrices for masked edge template pixels and masked non-edge template pixels may be incorporated, where the masked edge template matrix equals the Hadamard product of the similarity mask and the baseline template matrix (\hat{T}⁺=\hat{M}⊙\hat{T}), and the masked non-edge template matrix equals the difference between (i) the hadamard product of the similarity mask and the all-ones matrix and (ii) the baseline template matrix (\hat{T}⁻=\hat{M}⊙(1_{ŝ}_{y}×ŝₓ−\hat{T})). Similarly, the test image may be separated into edge matrices and non-edge matrices, where the test image edge matrix is the test image itself (I⁺=I), and the test image non-edge matrix is the difference between the all-ones matrix and the test image (I⁻=(1_{ŝ}_{y}×ŝₓ−I) In accordance with miscellaneous embodiments of the invention, the full score matrix can then be expressed as a weighted sum of convolutions with reversed kernels (i.e., S=w⁺·(\hat{T}+⊙I⁺)+w⁻·(\hat{T}−⊙I⁻)), where:
The first convolution operates between the reversed masked edge template matrix and the test image edge matrix, and
The second convolution operates between the reversed masked non-edge template matrix and the test image non-edge matrix.
   Each convolution may be weighted by its respective normalization factor: the reciprocal of the edge pixel count and the reciprocal of the non-edge pixel count.

This reformulation transforms the pixel-by-pixel similarity calculations into convolution operations, which can be efficiently computed using Fast Fourier Transforms (FFTs) in the frequency domain. The convolution approach enables simultaneous evaluation of template matching across all possible positions in the test image, rather than computing similarity scores sequentially at each position. Meanwhile, FFTs may enable efficient evaluation of weighted hamming similarity metrics in the frequency domain to achieve accelerated computation suitable for resource-constrained environments. Specifically, FFT-accelerated implementations may transform convolution operations from spatial domain calculations into frequency domain multiplications, thereby reducing computational complexity and enabling real-time template matching operations within tight timing constraints. The frequency domain evaluation may facilitate processing of large template and test images while maintaining computational efficiency compatible with single-core processors (e.g., processors operating at 200 MHz) with limited memory availability.

While specific processes are described above with reference to FIG. 8, weighted hamming similarity algorithms can be implemented in any of a number of different ways as appropriate to the requirements of specific applications in accordance with various embodiments of the invention. In many embodiments, steps may be executed or performed in any order or sequence not limited to the order and sequence shown and described. In numerous embodiments, some of the above steps may be executed or performed substantially simultaneously where appropriate or in parallel to reduce latency and processing times. In some embodiments, one or more of the above steps may be omitted. Additionally, the specific manner in which weighted hamming similarity algorithms can be utilized within localization systems in accordance with various embodiments of the invention is largely dependent upon the requirements of a given application.

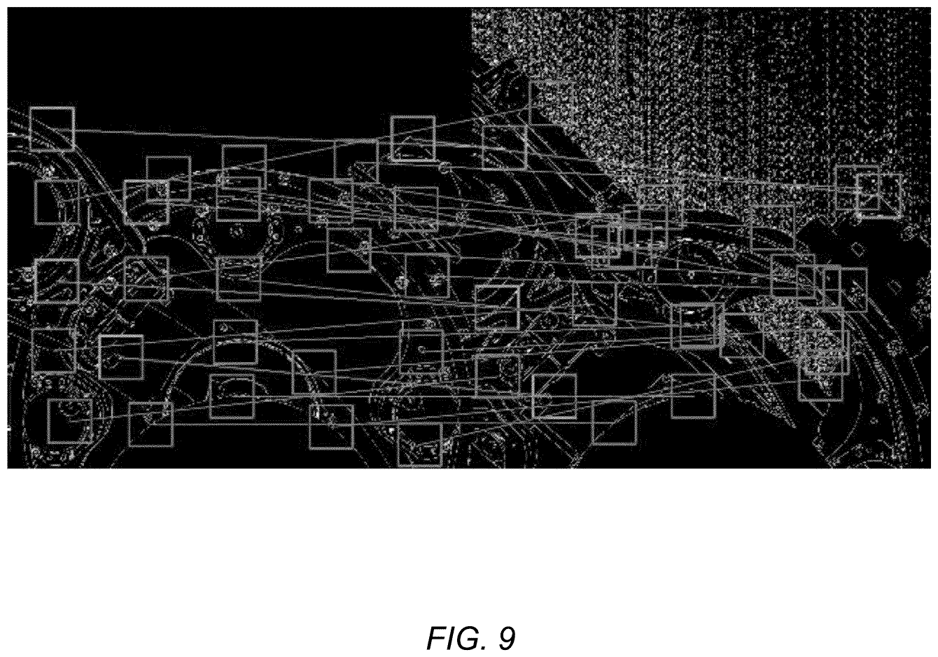

Referring to FIG. 9, weighted hamming similarity processes may produce visual representations of template matching operations between salient edge detection results and non-salient edge detection results. The weighted hamming similarity visualizations may demonstrate correspondence quality through color-coded pixel representations, where green pixels may indicate matching correspondences between template and test images and red pixels may indicate non-matching regions that contribute to similarity score calculations. The salient edge detection results shown on the left side of FIG. 9 may exhibit improved matching performance compared to non-salient edge detection results shown on the right side, thereby illustrating the advantages of salient edge rendering processes for template matching operations in localization systems.

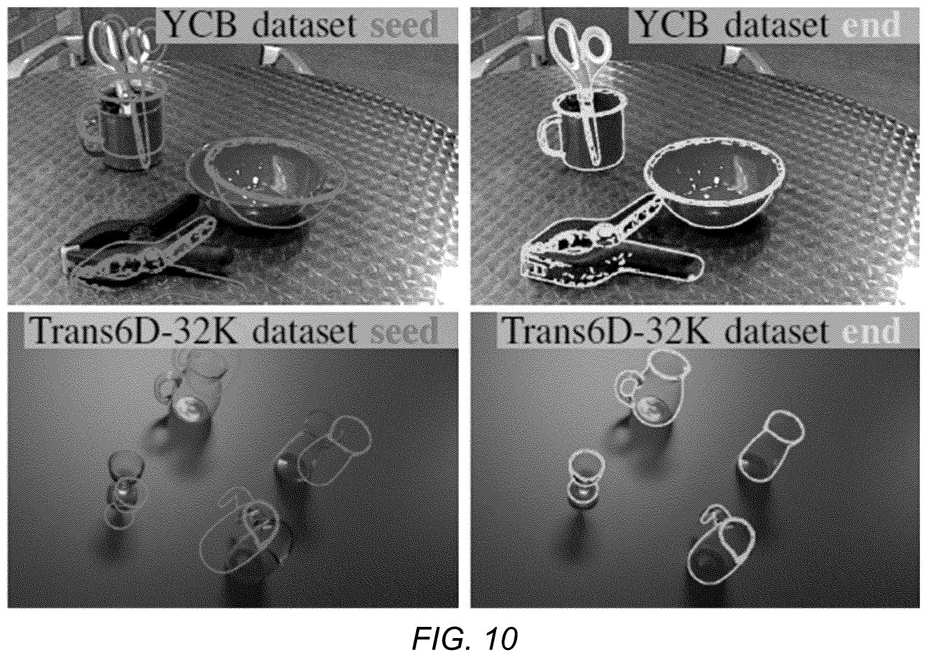

As shown in FIG. 10, weighted hamming similarity processes may demonstrate broad applicability across diverse object categories including but not limited to daily objects and transparent objects. The weighted hamming similarity applications may extend beyond specialized robotic localization scenarios to encompass general-purpose pose estimation tasks where edge-based template matching provides robust correspondence identification capabilities. The visualization examples in FIG. 10 may illustrate that weighted hamming similarity processes can maintain effectiveness across varying object geometries and surface properties, including but not limited to objects with complex edge patterns and objects with transparent or reflective surfaces that present challenges for conventional template matching approaches.

Localization systems in accordance with various embodiments of the invention may derive 2D-3D associations/correspondences/mappings from template matching operations to enable pose estimation through geometric correspondence analysis. The 2D-3D correspondence derivation may utilize controlled rendering processes that provide access to 3D points on target station models associated with baseline pixels, enabling establishment of correspondences between 3D model coordinates and 2D test image pixel locations. The template matching operations may generate mappings between baseline pixels and test pixels, where baseline pixels correspond to known 3D points on target station surfaces and test pixels correspond to observed features in captured images, thereby establishing the geometric relationships necessary for camera pose calculation. In various embodiments, this process may leverage depth buffer information generated during salient edge rendering to retrieve 3D coordinates corresponding to baseline template pixels. The depth buffer access may enable direct mapping from 2D baseline pixels to 3D surface points on target station models, providing geometric context for subsequent pose estimation calculations. The 2D-3D correspondences may serve as input data for perspective-n-point algorithms that calculate camera poses from sets of corresponding 2D image points and 3D model points.

Localization systems in accordance with various embodiments may implement Perspective-n-Point Random Sample Consensus (PnP-RANSAC) algorithms to calculate camera poses from 2D-3D associations while rejecting outlier correspondences that could degrade pose estimation accuracy. The PnP-RANSAC implementations may combine perspective-n-point geometric calculations with random sample consensus outlier rejection methods to achieve robust pose estimation despite the presence of incorrect correspondences generated during template matching operations. The PnP-RANSAC algorithms may, additionally or alternatively, iteratively sample subsets of 2D-3D associations to calculate candidate camera poses, then evaluate the quality of each candidate pose by measuring reprojection errors across all available correspondences.

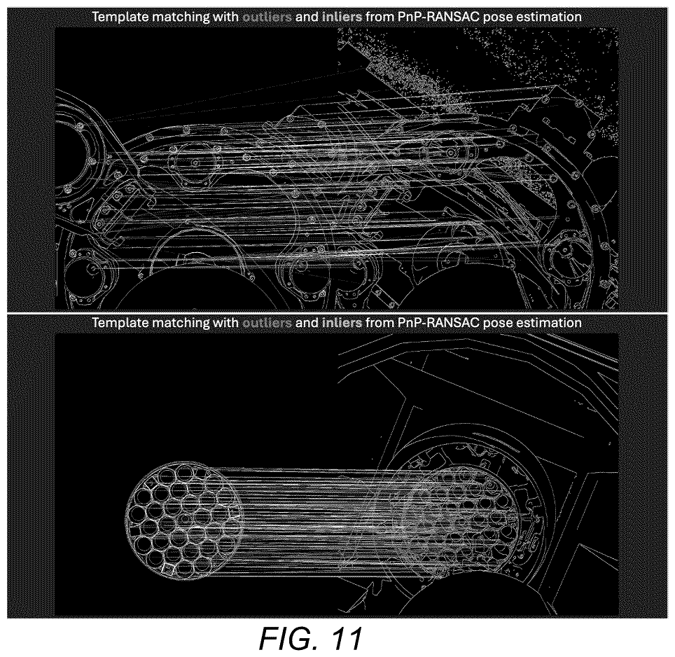

With reference to FIG. 11, PnP-RANSAC algorithms may classify correspondences as inliers or outliers based on reprojection error thresholds to improve pose estimation robustness. The template matching results may include both accurate correspondences that support correct pose estimation and erroneous correspondences that could lead to incorrect pose calculations if not properly identified and rejected. The PnP-RANSAC outlier rejection process may distinguish between inliers represented by green indicators and outliers represented by red indicators, where inliers correspond to associations that support the calculated camera pose within acceptable error tolerances and outliers correspond to associations that exhibit excessive reprojection errors indicating incorrect correspondence matching.

The PnP-RANSAC algorithms may utilize iteratively tightening reprojection error thresholds to progressively improve pose estimation accuracy throughout the localization process. The initial reprojection error threshold may be set to 8 pixels to accommodate initial pose uncertainties and potential correspondence errors during early iterations of the pose estimation process. The threshold reduction process may halve the reprojection error threshold two (or more) times over successive iterations, progressing from 8 pixels to 4 pixels to 2 pixels, thereby tightening the criteria for inlier classification as pose estimates converge toward accurate solutions. The iterative threshold tightening may enable robust pose estimation that initially accepts correspondences with moderate errors then progressively demands higher accuracy as the localization process advances toward convergence.

Localization systems in accordance with numerous embodiments of the invention may decompose 6-DoF pose errors into specific components to enable evaluation against dimensional requirements for robotic manipulation tasks. The 6-DoF error decomposition methodology may separate pose estimation errors into normal translation components, lateral translation components, and out-of-plane rotation components that correspond to different aspects of spatial positioning accuracy. The normal translation errors may correspond to positioning errors along camera depth axes, representing distance measurement accuracy between cameras and target stations. The lateral translation errors may correspond to positioning errors within image planes, representing the accuracy of target station localization in directions perpendicular to camera viewing directions. The out-of-plane rotation errors may correspond to angular errors between estimated and ground-truth camera depth axes, representing accuracy of camera orientation estimation relative to target station surfaces.

The error decomposition process may enable independent evaluation of localization performance across different spatial dimensions, allowing assessment of whether pose estimation accuracy meets specific requirements for each component of 6-DoF positioning. The dimensional error analysis may facilitate identification of localization performance limitations and optimization opportunities within specific aspects of pose estimation algorithms. The decomposed error measurements may provide detailed feedback for algorithm tuning and validation processes that ensure localization systems meet operational requirements across all relevant spatial dimensions.

Localization systems in accordance with some embodiments of the invention may implement comprehensive pose validation approaches that assess solution quality through multiple geometric consistency checks. The reprojection error analysis may evaluate pose estimates by projecting 3D model points onto image planes using calculated camera poses and measuring distances between projected locations and corresponding 2D feature points. The reprojection error thresholds may be progressively tightened from initial values of 8 pixels to final values of 2 pixels, enabling robust pose estimation that initially accepts correspondences with moderate errors then demands higher accuracy as convergence progresses.

Pose estimation systems in accordance with some embodiments of the invention may, additionally or alternatively, utilize iterative refinement schedules that control multiple algorithm parameters simultaneously to optimize convergence behavior. Template size schedules may start with 64×64 pixel templates for initial iterations then decay to 32×32, 16×16, and finally 8×8 pixel templates for successive iterations, balancing feature saliency with localization precision. The search area schedules may begin with regions spanning+50 pixels from predicted correspondence locations then tighten to +25, +12, and #6 pixels for subsequent iterations, reducing computational overhead while maintaining adequate search coverage.

In numerous embodiments of the invention, convergence criteria may incorporate multiple geometric measures to ensure robust pose estimation termination. For example, translation convergence threshold may require pose changes of less than 0.5 mm between consecutive iterations, while rotation convergence may demand angular changes of less than 0.5° to indicate stable pose estimates. The maximum iteration limit may be set at a certain threshold (e.g., 10 iterations) to prevent excessive processing time while providing adequate refinement opportunities for challenging localization scenarios. The early exit conditions may terminate processing when pose estimates exceed plausible ranges, typically defined as twice the input uncertainties, preventing convergence to physically impossible solutions.

Pose validation processes performed in accordance with multiple embodiments may implement geometric consistency checks that verify solution quality through multiple independent measures. The inlier ratio analysis may evaluate the percentage of 2D-3D correspondences that support the calculated pose within reprojection error thresholds, with minimum inlier ratios of 60-70% required for acceptable pose estimates. The pose stability assessment may compare consecutive pose estimates to ensure convergence toward consistent solutions, rejecting estimates that exhibit excessive variation between iterations. The geometric plausibility checks may verify that calculated poses fall within expected operational ranges based on mechanical constraints and mission planning parameters.

### II. Localization Evaluation

Localization systems in accordance with various embodiments of the invention have undergone comprehensive testing and experimentation to validate performance characteristics across synthetic datasets and physical testbeds. The testing methodologies may evaluate weighted hamming similarity processes against baseline approaches including but not limited to ORB feature matching, Sum of Squared Differences (SSD) template matching, Normalized Cross Correlation (NCC) template matching, and Local Feature TRansformer (LoFTR) methods. The experimental validation processes may assess completion rates, success rates within operational requirements, error statistics across multiple spatial dimensions, and computation times on resource-constrained processors to demonstrate feasibility for deployment in compute and memory-constrained environments.

a. Performance Metrics

Localization systems may operate within specific measurement requirements and initial uncertainties that define the operational constraints and performance targets for pose estimation processes. The accuracy requirements may specify translation tolerances of 0.4 mm and rotation tolerances of 0.25° that represent the maximum allowable errors for successful robotic manipulation operations including but not limited to sample tube pickup and insertion tasks. The initial uncertainties may encompass translation errors of 75 mm and rotation errors of 5° that represent the expected range of pose estimation errors before visual localization processing, establishing the baseline conditions from which localization systems must achieve the specified accuracy requirements.

The localization systems may handle rotationally symmetric objects where in-plane rotation considerations do not affect operational success for specific manipulation tasks. The rotationally symmetric object handling may recognize that sample tubes and insertion sleeves exhibit cylindrical symmetries that make in-plane rotation errors irrelevant for pickup and insertion operations, thereby focusing pose estimation accuracy requirements on translation and out-of-plane rotation components that directly impact manipulation success. The symmetric object considerations may enable localization systems to allocate computational resources toward pose estimation components that affect operational outcomes while avoiding unnecessary processing of rotation components that do not influence task performance.

Localization systems configured in accordance with numerous embodiments of the invention may utilize specific performance metrics to evaluate pose estimation accuracy and operational success across different spatial dimensions. The performance evaluation processes may decompose 6-DoF pose errors into normal translation errors, lateral translation errors, and out-of-plane rotation errors to enable dimensional analysis against operational requirements. The normal translation errors may be measured by projecting translation components along camera depth axes, while lateral translation errors may be determined by projecting translation components within image planes. The out-of-plane rotation errors may be calculated as angular differences between estimated and ground-truth camera depth axes, providing comprehensive assessment of pose estimation accuracy across all relevant spatial dimensions.

The performance metrics may classify localization runs as completed when pose estimation processes converge to any pose solution, regardless of accuracy, and as successful when all error components simultaneously fall within operational requirements across all dimensions. The operational requirements may specify maximum allowable errors of 0.4 mm for translation components and 0.25° for rotation components, representing the accuracy thresholds necessary for successful robotic manipulation operations. The performance evaluation processes may calculate completion rates as percentages of test cases that achieve convergence, success rates as percentages of completed runs that meet accuracy requirements, and error statistics including but not limited to average values, standard deviations, and maximum observed errors across each spatial dimension.

b. Synthetic Evaluation

Localization systems may undergo evaluation against synthetic datasets comprising 2000 test images for each target station type, generated through ray-tracing processes that simulate physically realistic operational conditions. The synthetic evaluation processes may assess performance across multiple baseline approaches to establish comparative effectiveness of weighted hamming similarity methods. ORB feature matching approaches may achieve 0.0% completion rates on rover bit carousel test cases and 45.6% completion rates on lander orbiting sample test cases, with only 21.1% of completed lander orbiting sample localizations meeting accuracy requirements. The ORB performance limitations may result from discrepancies between physically realistic ray-traced test images and low-fidelity rasterization processes that make low-level descriptor matching challenging, particularly for geometries with fewer distinctive corner features.

Sum of Squared Differences template matching processes may demonstrate limited effectiveness with 2.1% completion rates on rover bit carousel cases and 43.6% completion rates on lander orbiting sample cases. The SSD performance limitations may arise from inherent sensitivity to absolute intensity values rather than relative intensity distributions, which basic rendering techniques cannot accurately capture. Normalized Cross Correlation template matching processes may achieve improved performance with 94.3% completion rates on rover bit carousel cases and 98.7% completion rates on lander orbiting sample cases, demonstrating greater robustness to illumination changes compared to SSD approaches. However, NCC methods may produce false positive results in 6.0% of rover bit carousel cases, where incorrect pose estimates converge outside accuracy requirements with lateral errors reaching 57.3 mm, representing potential failure modes for mission-critical applications.

Local Feature TRansformer methods may demonstrate variable performance depending on implementation approaches. LoFTR resize variants may achieve 100.0% completion rates and 98.0% success rates on rover bit carousel cases, but may still produce 2.0% false positive results exceeding rotational requirements. LoFTR subframe variants may exhibit reduced performance with 99.5% completion rates and 91.0% success rates on rover bit carousel cases, potentially due to increased noise in correspondence matching when processing full-resolution images containing largely texture-less regions. On lander orbiting sample cases, LoFTR methods may encounter challenges with repeating geometric patterns, achieving only 22.3% success rates despite 95.0% completion rates, as the models may erroneously match different sleeve positions resulting in pose estimates offset by multiple sleeve widths.

Weighted hamming similarity processes configured in accordance with various embodiments of the invention may achieve 100.0% success rates on both rover bit carousel and lander orbiting sample test cases, demonstrating superior performance compared to baseline approaches. The weighted hamming similarity methods may produce no false positive results while maintaining error distributions with average normal translation errors of 0.005 mm and 0.012 mm for rover bit carousel and lander orbiting sample cases, respectively. The lateral translation errors may average 0.083 mm and 0.167 mm respectively, while rotation errors may average 1.143 mrad and 2.725 mrad respectively, all falling well within operational requirements and demonstrating consistent accuracy across different target station geometries.

c. Real-World Evaluation

Localization systems may undergo validation using real-world imagery from physical testbeds and in-situ Mars environments to assess performance under actual operational conditions. The real-world evaluation processes may utilize 20 testbed images for each target station type and 6 Mars images captured by rover cameras at different standoff distances and times of day. The testbed evaluation results may demonstrate significant performance degradation for baseline approaches when transitioning from synthetic to real imagery. ORB feature matching processes may achieve 0.0% completion rates across all real-world test scenarios, while SSD template matching may achieve limited success with 45.0% success rates on testbed lander orbiting sample cases and 0.0% success rates on all other scenarios.

Normalized Cross Correlation (NCC) methods may experience substantial performance reduction in real-world conditions, achieving only 45.0% success rates on testbed lander orbiting sample cases and 0.0% success rates on testbed rover bit carousel and Mars imagery cases. The NCC performance degradation may illustrate challenges associated with bridging gaps between basic onboard shading calculations and realistic environmental conditions, where factors including but not limited to dust accumulation, atmospheric effects, and lighting variations cannot be accurately modeled through low-fidelity rendering approaches. Local Feature TRansformer methods may demonstrate improved real-world performance on rover bit carousel cases, achieving 95.0% and 100.0% success rates on testbed and Mars imagery respectively, though maintaining only 5.0% success rates on testbed lander orbiting sample cases due to confusion between repeating geometric patterns.

Weighted hamming similarity processes may demonstrate robust real-world performance, achieving 100.0% success rates across all testbed scenarios and near-distance Mars imagery cases. The weighted hamming similarity methods may maintain effectiveness despite years of unmodeled dust accumulation on Mars hardware and reduced surface resolution conditions, with Mars rover cameras operating at 166 micrometers per pixel compared to planned lander camera resolutions of 128 micrometers per pixel. The robust real-world performance may illustrate the effectiveness of salient edge rendering combined with weighted hamming similarity for bridging sim-to-real gaps without requiring high-fidelity environmental modeling or complex lighting calculations.

The far-distance Mars imagery evaluation may present challenges for all tested approaches due to surface resolution limitations. At 123 cm standoff distances, Mars rover cameras may operate at 417 micrometers per pixel surface resolution, representing 3× degradation compared to planned lander camera specifications. Under these conditions, weighted hamming similarity processes may meet requirements for normal and lateral translation components but may not achieve rotational accuracy requirements, as 16 mrad requirement-breaking rotations correspond to image feature movements of less than 1/20th of a pixel, making such angular errors essentially imperceptible at the available resolution.

d. Computation Times

Localization systems configured in accordance with multiple embodiments of the invention may operate within computational constraints imposed by single-core 200 MHz processors with limited memory availability. The computation time analysis may evaluate processing requirements across different algorithm components including but not limited to initialization operations, viewpoint hypothesis rendering, feature or template matching processes, and pose update calculations. The timing evaluations may demonstrate that weighted hamming similarity processes complete localization operations within allocated time budgets while maintaining superior accuracy compared to baseline approaches.

Initialization and rendering operations may consume similar time allocations across different approaches, with initialization processes requiring approximately 1.1-1.4 minutes and rendering operations requiring approximately 6.9-8.1 minutes per localization cycle. The rendering operations may represent significant portions of total computation time budgets, consuming approximately 7 minutes out of 30 minutes available for complete localization of both target stations, thereby representing potential targets for future optimization efforts. The rendering time requirements may remain consistent across approaches since all methods utilize similar 3D models and generate baseline images from comparable viewpoint hypotheses.

Template matching operations may represent the primary computational differentiator between approaches, with ORB feature matching requiring less than 1 minute due to computationally efficient detection and description processes. Sum of Squared Differences and Normalized Cross Correlation methods may require approximately 3.6-3.7 minutes for template matching operations, reflecting increased computational costs associated with convolution calculations between large templates and test images. Weighted hamming similarity processes may require approximately 13.2 minutes for template matching operations in current implementations, representing approximately 4× increase compared to SSD and NCC methods, though theoretical optimizations may reduce this overhead to 2× through optimized Fast Fourier Transform implementations and improved data structures.

Local Feature TRansformer (LoFTR) methods may require substantially greater computational resources, with extrapolated timing estimates indicating 11-36 hours for complete localization operations on 200 MHz processors. The LoFTR computational requirements may exceed available memory constraints, requiring 3.8 GB of RAM compared to 10 MB available on flight processors, thereby making deep learning approaches currently incompatible with resource-constrained operational environments. The computational analysis may indicate that deep learning methods require faster radiation-hardened processors or alternative architectures including but not limited to GPU or FPGA implementations to achieve viability for space applications.

Weighted hamming similarity processes may complete total localization operations in approximately 21.33 minutes, representing successful operation within 30-minute time budgets while maintaining comfortable margins of approximately 40% for additional processing or contingency operations. The pose update calculations may require minimal time allocations of approximately 0.02 minutes for weighted hamming similarity approaches, reflecting improved correspondence quality that enables PnP-RANSAC algorithms to converge in fewer iterations compared to baseline methods. The overall timing performance may demonstrate that weighted hamming similarity processes achieve superior accuracy while operating within computational constraints imposed by resource-limited environments, enabling deployment in applications where both accuracy and efficiency requirements must be simultaneously satisfied.

### III. Localization Systems

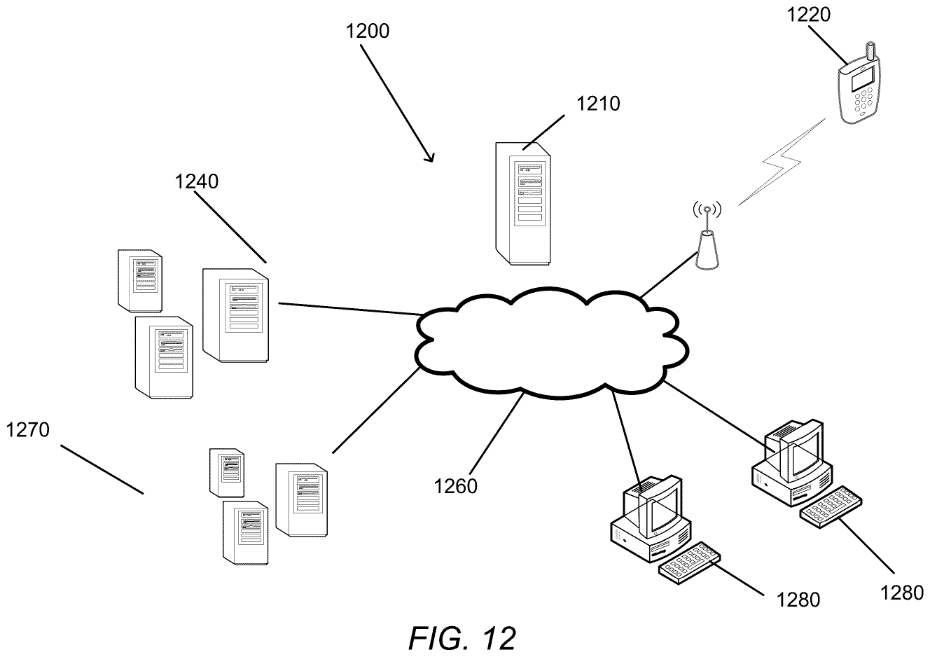

An example of a localization system that performs robust monocular 6-DoF pose estimation in compute and memory-constrained environments in accordance with some embodiments of the invention is illustrated in FIG. 12. A localization system 1200 may include but is not limited to a communications network 1260. The communications network 1260 may be a network such as the Internet that allows devices connected to the communications network 1260 to communicate with other connected devices. Server systems 1210, 1240, and 1270 are connected to the communications network 1260. Each of the server systems 1210, 1240, and 1270 may be a group of one or more servers communicatively connected to one another via internal networks that execute processes that provide cloud services to users over the communications network 1260. One skilled in the art will recognize that a localization system may exclude certain components and/or include other components that are omitted for brevity without departing from this invention.

For purposes of this discussion, cloud services may be one or more applications that are executed by one or more server systems to provide data and/or executable applications to devices over a network. The server systems 1210, 1240, and 1270 are shown each having three servers in the internal network. However, the server systems 1210, 1240 and 1270 may include any number of servers and any additional number of server systems may be connected to the communications network 1260 to provide cloud services. In accordance with various embodiments of this invention, a localization system that uses systems and methods that perform salient edge rasterization and weighted hamming similarity processes in accordance with several embodiments of the invention may be provided by a process being executed on a single server system and/or a group of server systems communicating over the communications network 1260.

Users may use personal devices 1280 and mobile devices 1220 that connect to the communications network 1260 to perform processes that execute localization algorithms in accordance with various embodiments of the invention. In the shown embodiment, the personal devices 1280 are shown as desktop computers that are connected via a conventional “wired” connection to the communications network 1260. However, a personal device 1280 may be a desktop computer, a laptop computer, a smart television, an entertainment gaming console, or any other device that connects to the communications network 1260 via a “wired” connection. A mobile device 1220 connects to the communications network 1260 using a wireless connection. A wireless connection may be a connection that uses Radio Frequency (RF) signals, Infrared signals, or any other form of wireless signaling to connect to the communications network 1260. In the example of this figure, the mobile device 1220 may be a mobile telephone. However, the mobile device 1220 may be a mobile phone, Personal Digital Assistant (PDA), a tablet, a smartphone, or any other type of device that connects to the communications network 1260 via wireless connection without departing from this invention.

As can readily be appreciated the specific computing system used to perform localization operations may be largely dependent upon the requirements of a given application and should not be considered as limited to any specific computing system(s) implementation. The distributed computing architecture may enable deployment of localization systems across various operational environments including but not limited to space missions, terrestrial robotics applications, and general-purpose pose estimation tasks where computational resources may be distributed between local processing units and remote server systems.

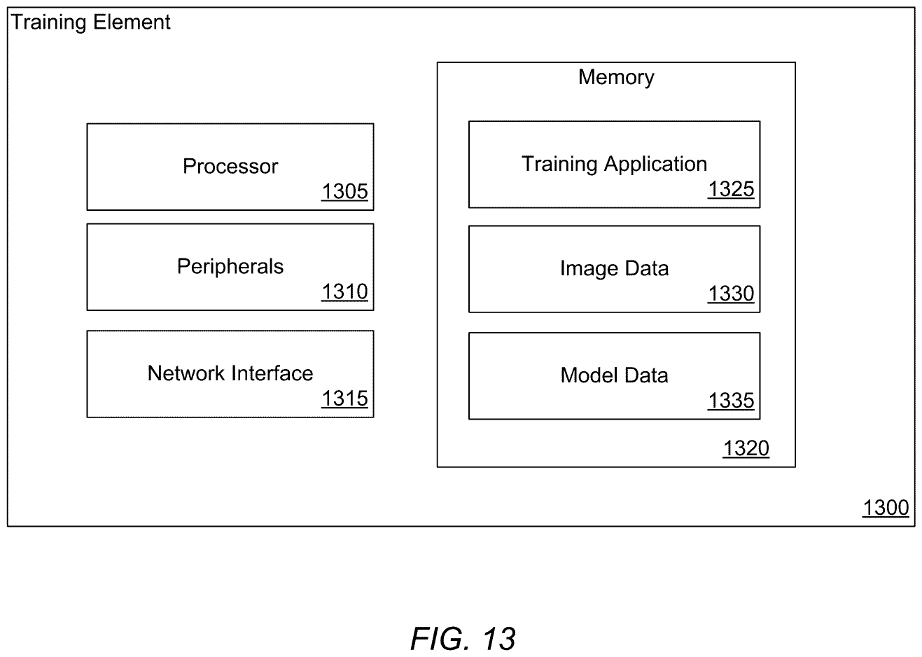

An example of a training element that executes instructions to perform processes that train localization models in accordance with many embodiments of the invention is illustrated in FIG. 13. Training elements in accordance with many embodiments of the invention can include (but are not limited to) one or more of mobile devices, cameras, and/or computers. A training element 1300 includes a processor 1305, peripherals 1310, a network interface 1315, and memory 1320. One skilled in the art will recognize that a training element may exclude certain components and/or include other components that are omitted for brevity without departing from this invention.

The processor 1305 can include (but is not limited to) a processor, microprocessor, controller, or a combination of processors, microprocessor, and/or controllers that performs instructions stored in the memory 1320 to manipulate data stored in the memory. Processor instructions can configure the processor 1305 to perform processes in accordance with certain embodiments of the invention. In various embodiments, processor instructions can be stored on a non-transitory computer-readable and/or machine-readable medium. Computer-readable and/or machine-readable storage may include instructions, when executed, to implement a method or realize an apparatus in any of the examples of the present application. The processor 1305 may execute processors including but not limited to salient edge rendering algorithms, weighted hamming similarity calculations, and PnP-RANSAC pose estimation processes to enable localization system training and validation operations.

The peripherals 1310 can include any of a variety of components for capturing data, such as (but not limited to) cameras, displays, and/or sensors. In a variety of embodiments, peripherals can be used to gather inputs and/or provide outputs. The training element 1300 can utilize the network interface 1315 to transmit and receive data over a network based upon the instructions performed by the processor 1305. Peripherals and/or network interfaces in accordance with many embodiments of the invention can be used to gather inputs that can be used to train localization models through capture of test images and generation of ground truth pose data for algorithm validation processes.

The memory 1320 includes a training application 1325, image data 1330, and model data 1335. Training applications in accordance with several embodiments of the invention can be used to develop and validate localization algorithms through processing of synthetic datasets, testbed imagery, and real-world operational data. The training application 1325 may implement render-and-compare algorithms, salient edge rendering processes, and weighted hamming similarity methods to enable comprehensive evaluation of localization system performance across diverse operational scenarios.

The image data 1330 in accordance with a variety of embodiments of the invention can include various types of multimedia data that can be used in evaluation processes. In certain embodiments, the image data 1330 can include (but is not limited to) synthetic ray-traced images, testbed photographs, Mars rover imagery, intensity images, edge maps, and depth buffer representations. The image data 1330 may encompass test images captured from cameras with specific poses, baseline images synthesized from virtual camera pose hypotheses, and ground truth annotations that enable quantitative assessment of localization accuracy across multiple spatial dimensions.

In several embodiments, the model data 1335 can store various parameters and/or weights for various models that can be used for various processes as described in this specification. The model data 1335 in accordance with many embodiments of the invention can be updated through training on multimedia data captured on a training element or can be trained remotely and updated at a training element. The model data 1335 may include 3D mesh models of target stations, camera calibration parameters, salient edge threshold values, template matching optimization schedules, and PnP-RANSAC configuration parameters that enable localization systems to achieve accurate pose estimation within operational requirements.

The training element 1300 may facilitate development of localization systems that operate under severe computational constraints while maintaining accuracy requirements for robotic manipulation tasks. The training processes may utilize the processor 1305 to execute iterative pose refinement algorithms, the peripherals 1310 to capture validation imagery from physical testbeds, the network interface 1315 to access distributed computational resources, and the memory 1320 to store training datasets and model parameters. The training element 1300 may enable comprehensive validation of localization system performance across synthetic datasets, physical testbeds, and real-world operational environments to ensure robust deployment in resource-constrained applications.

Although a specific example of a training element 1300 is illustrated in this figure, any of a variety of training elements can be utilized to perform processes for developing localization systems similar to those described herein as appropriate to the requirements of specific applications in accordance with embodiments of the invention. The training element architecture may be adapted to support various computational environments including but not limited to single-core processors operating at 200 MHz with limited memory availability, distributed cloud computing systems, and specialized hardware configurations designed for space applications or other resource-constrained operational scenarios.

Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. The eNB (or other base station) and UE (or other mobile station) may also include a transceiver component, a counter component, a processing component, and/or a clock component or timer component. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or an interpreted language, and combined with hardware implementations.

It should be understood that many of the functional units described in this specification may be implemented as one or more components, which is a term used to emphasize their implementation independence more particularly. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, and the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present invention. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the invention is not to be limited to the details given herein, but may be modified within the scope and equivalents of the appended claims.

Those having skill in the art will appreciate that many changes may be made to the details of the above-described embodiments without departing from the underlying principles of the invention. The scope of the present invention should, therefore, be determined only by the following claims.

1. A method for robust visual localization in compute-constrained environments, the method comprising:
deriving, from a camera with a specific pose, at least one test image depicting a scene including a target area;
generating a three-dimensional (3D) mesh model corresponding to the target area depicted in the scene, wherein the 3D mesh model comprises a plurality of object polygons;
iterating over each of the plurality of object polygons to build a depth map of the target area;
identifying a set of salient edges corresponding to the depth map, wherein the set of salient edges is identified according to a pre-determined discontinuity threshold for depth estimates on the depth map;
deriving an ideal edge map for the target area from the set of salient edges;
synthesizing at least one baseline image of a virtual representation of the scene from the perspective of an initial camera pose, wherein the at least one baseline image comprises the ideal edge map; and
performing template matching between the at least one test image and the at least one baseline image to derive a mapping for estimating the specific pose.

2. The method of claim 1, further comprising iteratively updating the initial camera pose based on the mapping to estimate the specific pose until convergence criteria are met.

3. The method of claim 2, wherein the convergence criteria comprise pose changes of less than 0.5 mm for translation and less than 0.5 degrees for rotation between consecutive iterations.

4. The method of claim 1, wherein performing template matching comprises:
generating a binary edge map corresponding to each of the at least one test image and a template image extracted from the at least one baseline image;
determining a similarity mask for the template image based on whether each individual pixel corresponds to rendered object material or should be ignored;
quantifying pixels that are simultaneously edges or simultaneously non-edges on both the test image and template image; and
deriving a weighted hamming similarity score from the similarity mask, test image, template image, and quantified pixels as a weighted sum to evaluate similarity between the test image and template image.

5. The method of claim 4, wherein generating the binary edge map corresponding to the at least one test image comprises applying Canny edge detection to an intensity image captured by the camera.

6. The method of claim 1, further comprising:
establishing 2D-3D correspondences between pixels in the at least one test image and 3D points on the target area using the mapping; and
calculating a best-fitting camera pose from the 2D-3D correspondences using a Perspective-n-Point Random Sample Consensus algorithm.

7. The method of claim 6, wherein the Perspective-n-Point Random Sample Consensus algorithm classifies the 2D-3D correspondences as inliers or outliers based on reprojection error thresholds that are progressively tightened during iterative pose refinement.

8. A localization system for robust visual localization in compute-constrained environments, the system comprising:
a camera;
a memory storing instructions; and
a processor configured to execute the instructions to:
derive, from the camera, when the camera has a specific pose, at least one test image depicting a scene including a target area;
generate a three-dimensional (3D) mesh model corresponding to the target area depicted in the scene, wherein the 3D mesh model comprises a plurality of object polygons;
iterate over each of the plurality of object polygons to build a depth map of the target area;
identify a set of salient edges corresponding to the depth map, wherein the set of salient edges is identified according to a pre-determined discontinuity threshold for depth estimates on the depth map;
derive an ideal edge map for the target area from the set of salient edges;
synthesize at least one baseline image of a virtual representation of the scene from the perspective of an initial camera pose, wherein the at least one baseline image comprises the ideal edge map; and
perform template matching between the at least one test image and the at least one baseline image to derive a mapping for estimating the specific pose.

9. The localization system of claim 8, wherein the memory further stores instructions that, when executed by the processor, cause the system to iteratively update the initial camera pose based on the mapping to estimate the specific pose until convergence criteria are met.

10. The localization system of claim 9, wherein the convergence criteria comprise pose changes of less than 0.5 mm for translation and less than 0.5 degrees for rotation between consecutive iterations.

11. The localization system of claim 8, wherein performing template matching comprises:
generating a binary edge map corresponding to each of the at least one test image and a template image extracted from the at least one baseline image;
determining a similarity mask for the template image based on whether each individual pixel corresponds to rendered object material or should be ignored;
quantifying pixels that are simultaneously edges or simultaneously non-edges on both the test image and template image; and
deriving a weighted hamming similarity score from the similarity mask, test image, template image, and quantified pixels as a weighted sum to evaluate similarity between the test image and template image.

12. The localization system of claim 11, wherein generating the binary edge map corresponding to the at least one test image comprises applying Canny edge detection to an intensity image captured by the camera.

13. The localization system of claim 8, wherein the memory further stores instructions that, when executed by the processor, cause the system to:
establish 2D-3D correspondences between pixels in the at least one test image and 3D points on the target area using the mapping; and
calculate a best-fitting camera pose from the 2D-3D correspondences using a Perspective-n-Point Random Sample Consensus algorithm.

14. The localization system of claim 13, wherein the Perspective-n-Point Random Sample Consensus algorithm classifies the 2D-3D correspondences as inliers or outliers based on reprojection error thresholds that are progressively tightened during iterative pose refinement.

15. A non-transitory computer-readable medium comprising instructions that, when executed, are configured to cause a processor to perform a method for robust visual localization in compute-constrained environments, the method comprising:
deriving, from a camera with a specific pose, at least one test image depicting a scene including a target area;
generating a three-dimensional (3D) mesh model corresponding to the target area depicted in the scene, wherein the 3D mesh model comprises a plurality of object polygons;
iterating over each of the plurality of object polygons to build a depth map of the target area;
identifying a set of salient edges corresponding to the depth map, wherein the set of salient edges is identified according to a pre-determined discontinuity threshold for depth estimates on the depth map;
deriving an ideal edge map for the target area from the set of salient edges;
synthesizing at least one baseline image of a virtual representation of the scene from the perspective of an initial camera pose, wherein the at least one baseline image comprises the ideal edge map; and
performing template matching between the at least one test image and the at least one baseline image to derive a mapping for estimating the specific pose.

16. The non-transitory computer-readable medium of claim 15, wherein the method further comprises iteratively updating the initial camera pose based on the mapping to estimate the specific pose until convergence criteria are met.

17. The non-transitory computer-readable medium of claim 16, wherein the convergence criteria comprise pose changes of less than 0.5 mm for translation and less than 0.5 degrees for rotation between consecutive iterations.

18. The non-transitory computer-readable medium of claim 15, wherein performing template matching comprises:
generating a binary edge map corresponding to each of the at least one test image and a template image extracted from the at least one baseline image;
determining a similarity mask for the template image based on whether each individual pixel corresponds to rendered object material or should be ignored;
quantifying pixels that are simultaneously edges or simultaneously non-edges on both the test image and template image; and
deriving a weighted hamming similarity score from the similarity mask, test image, template image, and quantified pixels as a weighted sum to evaluate similarity between the test image and template image.

19. The non-transitory computer-readable medium of claim 18, wherein generating the binary edge map corresponding to the at least one test image comprises applying Canny edge detection to an intensity image captured by the camera.

20. The non-transitory computer-readable medium of claim 15, wherein the method further comprises:
establishing 2D-3D correspondences between pixels in the at least one test image and 3D points on the target area using the mapping; and
calculating a best-fitting camera pose from the 2D-3D correspondences using a Perspective-n-Point Random Sample Consensus algorithm.
